(19) United States
(12) Patent Application Publication
(10) Pub. No.: US 2004/0093299 A1
(43) Pub. Date: May 13, 2004

(54) System and method for coalescing information for presentation to a vehicle operator

(75) Inventors: William Kress Bodin, Austin, TX (US); Derral C. Thorson, Austin, TX (US)

Correspondence Address: Robert H. Frantz, P.O. Box 23324, Oklahoma City, OK, 73123, US

(73) Assignee: International Business Machines Corporation, Armonk, NY

(21) Appl. No.: 10/290,381

(22) Filed: Nov. 7, 2002

(51) Int. Cl. G06F 17/60

(52) U.S. Cl. 705/37

(57) ABSTRACT

Multiple “opportunities” or offers for service or product are coalesced for presentation to a vehicle operator via an In-Vehicle Information System (“IVIS”) according to user preferences, IVIS modal characteristics and capabilities, and vehicle conditions and state. Opportunities may include offers and quotes for services or products which have been provided by one or more potential vendors in response to a request from the vehicle's on-board diagnostic systems or from a user-initiated query. Presentation of such opportunities may include text displays, color displays, graphic images, moving images (e.g. video clips), and/or audio. By coalescing the opportunities prior to presentation to the vehicle operator, user preferences are applied such as filtering and sorting for preferred vendors, price and availability, IVIS presentation capabilities, and conditions of the vehicle are considered such as avoiding presenting distracting object types during high speed vehicle operation.

### CROSS-REFERENCE TO RELATED APPLICATIONS (CLAIMING BENEFIT UNDER 35 U.S.C. 120)

This patent application is related to U.S. patent application Ser. No. 10/232,246 filed on Aug. 29, 2002, docket number AUS920020344US1, by William Kress Bodin, et al., entitled “Anticipatory Mobile System Service Brokering and Resource Planning from Multiple Providers”.

### FEDERALLY SPONSORED RESEARCH AND DEVELOPMENT STATEMENT

This invention was not developed in conjunction with any Federally sponsored contract.

### MICROFICHE APPENDIX

Not applicable.

### INCORPORATION BY REFERENCE

Not Applicable.

### BACKGROUND OF THE INVENTION

1. Field of the Invention

This invention relates to the presentation of information such as offers and opportunities to an operator of a vehicle such as, but not limited to, an automobile, train, truck, ship, or aircraft.

2. Background of the Invention

Vehicles are traditionally designed and built with a finite set of gauges or indicator warning lights which are intended to convey vital operational status to the operator of the vehicle. For example, many automobiles are equipped with a temperature gauge or warning light, and an oil pressure gauge or warning light, on the dashboard. If a temperature gauge enters a range indicating higher than normal operating coolant temperature, the driver may choose to continue driving until a service station is reached. For indicator lights, often referred to as “dummy lights”, the light may be illuminated when the temperature has reached a critical point, leaving the driver with even fewer options (e.g. less time to find a service station). Most automobiles, however, are equipped many sensors in the engine, electrical, electronic, and drive train subsystems, which provide more information regarding the status of the engine. This detailed information, however, is not usually presented to the driver, but is maintained in memory by an on-board computer for later analysis by an automotive technician and/or diagnostic computer. During the operation of the vehicle, the on-board computer may simply determine if a sensor indicates a potential problem and decide to illuminate a warning light.

Most modern vehicles, including ships, aircraft, trains, trucks and cars, follow this convention of collecting a large amount of sensor and indicator data from the vehicle's subsystems, storing these data items in memory, and presenting simple, “high level” indicators to the vehicle operator (e.g. pilot, captain, etc.).

So, for example, when a driver sees an over-temperature indicator light or notices a temperature gauge in the “hot” range, he must make a fairly uninformed decision as to how to proceed. If he is driving on a highway, he must decide to “chance it” and continue driving until the next town or service center is reached in the hopes that an appropriately-equipped and staffed repair shop will be found. By doing so, he risks causing expensive damage to the vehicle's engine. If he chooses to take such a risk and upon arrival at the next town finds that no appropriately equipped or staffed shop is available, he may have to pay for a tow anyway, thereby finding that he incurred the risk of engine damage unnecessarily (e.g. he could have stopped on the roadside and called for a tow).

This particular problem has become even more pronounced as the automobile industry has diversified in recent years. Many consumers are purchasing vehicles which are made by manufacturers who have small portions of market share in the country where they reside, and thus there are fewer repair centers which are equipped with the diagnostic equipment for his or her particular make-and-model of vehicle and who have appropriately trained staff for the needed repair. In one example, a driver may have a car which cannot be serviced by any shop in the next town because it is manufactured by a company which does not have a dealer in town. In another example situation, a dealer for the driver's car may be in town, but the malfunction may be in a subsystem for which the dealer does not have a trained technician currently on staff or on call (e.g. a problem within the transmission but the dealer has no transmission technicians on staff). A third aspect of whether or not service can be obtained as needed is whether or not a service center has ready access to spare parts and replacement components, as may be required.

All travel is time dependent (e.g. there is an itinerary to be kept), whether it is a road trip in a car by a private consumer, a transoceanic shipment by ship or a scheduled airline flight, and as such, all of these factors must be met in a timely fashion to minimize the economic, social, and financial impact of a vehicle repair:

(a) availability of an appropriate business entity to provide the service (e.g. car repair shop, aircraft maintenance depot, etc.);

(b) availability of appropriately skilled service personnel;

(c) availability necessary facilities, tools and systems (e.g. diagnostic systems, repair tools, etc.); and

(d) availability of components and repair parts.

In most cases, another factor of obtaining service is whether or not the price or cost of the service is acceptable to the operator of the vehicle. In some cases, such as having a car indicator illuminate while on a cross-country trip or visiting a city away from home, the driver may anticipate being charged an exorbitant amount for a routine repair, and as such, may decide not to seek service until returning to his or her home town, further increasing his or her risk for greater vehicle damage and possibly causing safety problems.

As a result, while ample diagnostic information to determine a needed service and replacement component is often collected by vehicle on-board computers and sensors, and while some operational time before arriving at a point of possible service is often available (e.g. driving time to next town, flight time to land at next airport, travel time to next train depot, etc.), this time is not wisely used to search for appropriate service providers and to negotiate for acceptable service cost. Normally, the operator of the vehicle will begin these processes after arriving at the next point of service, which may incur additional costs (e.g. overnight shipping of parts, hotel stays, rental vehicles, etc.) and may cause undesirable delays to the itinerary.

Many vehicle operators and vehicles are equipped with communications systems (e.g. radio, wireless telephones, etc.) which allow them to communicate to some degree their problem while in transit, and to attempt to set arrangements for service at the next point of service. However, this can be ineffective as it can be very difficult, for example, for a car driver to obtain quotes for parts and service while driving on a highway, especially because he or she is not privy to the detailed error codes stored in the on-board computer's memory thereby making an accurate diagnosis difficult.

Still other systems, such as General Motor's On Star™ system, provides for triggering of communications such as a cell telephone to call to an operator when certain conditions are detected, such as deployment of an airbag. Generally, this only helps the driver get in contact with possible assistance, but does not relieve the driver of the mental distraction trying to describe a problem and to negotiate for a service action. Another potentially useful service are cellular-based concierge services, which allows a driver to call a single point of contact to initiate assistance such as scheduling a car maintenance appointment. These services, however, are more general purpose in nature (e.g. making hotel reservations, obtaining show tickets, etc.), and are of limited assistance with handling detailed vehicle trouble and maintenance discussions. In either of these cases, the on-board diagnostic information is neither available to the driver, the assisting telephone operator or concierge for accurate and precise planning of a maintenance service.

Therefore, there is a need in the art for a system and method which utilizes the time available between the first time of detection of a potential problem on a mobile system or vehicle in transit and the time to arrival at a point of service to determine potential providers, obtain quotes from the service providers, select a provider and schedule the service action such that itinerary impact is minimized, safety and convenience to the vehicle operator is maximized, and exorbitant unexpected expenses are eliminated.

In the related patent application, which has been incorporated herein, a system and method were disclosed which could automatically obtain a plurality of “quotes” or offers from a plurality of vendors or suppliers, to filter those offers based upon the vehicle operator's preferences, to transmit them to the vehicle and to display them to the vehicle operator.

However, as these “quotes” and offers may be provided by the bidding responders in a variety for formats, there is a need for a system and method to coalesce these offers into a format readily comprehendable by the vehicle operator. For example, one responding bidder may provide a graphically-rich electronic bid, such as Hyper Text Markup Language (“HTML”) document with text, color, high resolution graphics and sound. Another responding bidder may provide an offer in a simple, text-only format.

Depending on many factors, these offers may need further processing before presentation to the vehicle driver. For example, some vehicles may not be provided with a color display capable of presenting color text and graphics. Other vehicles may not be able to play sound to the operator. As these are relatively “static” characteristics of the vehicle and its equipment, there are dynamic factors relating to the vehicle's condition and operation which also may effect the desirability of types of information presented to the vehicle operator. If the vehicle is currently being operated at a high speed or in a critical condition (e.g. highway driving in a car or landing an aircraft), it may be undesirable to present video and audio content to the operator as it may cause a distraction to safe operation of the vehicle, for example.

In addition to the preceding example of brokering and arranging for vehicle service or maintenance, in vehicle information systems (“IVIS”) also represent an opportunity for the vehicle operator to seek, negotiate, and secure other types of services, offers, and quotes while in transit. For example, a driver traveling on a highway may wish to obtain rates and availability for hotel rooms in advance of arriving in a town or city. Under normal conditions without an IVIS, the driver would either have to make several cell phone calls (assuming he or she had access to the appropriate telephone numbers), or would have to contact a secretary or concierge service to do the searching for him or her. In the former case, like the situation of obtaining vehicle maintenance, it can be dangerous and even impractical for the driver to contact several hotels, get quotes, compare them, and call the “winning” or selected hotel back to secure a reservation. In the latter case, a secretary or concierge service may not be available (e.g. late night travel), or may be expensive.

As such, the paradigm addressed by the system and method disclosed in the related application can be extended to assist with operator-initiated offer collection such as, but not limited to, finding hotel accommodations, making meal and restaurant reservations, booking entertainment tickets, etc. These types of transactions will also result in the collection of several offers or quotes which must be presented to the vehicle operator. These offers or opportunities may be provided with a variety of content types (text, color, graphics, audio, video, etc.), which may or may not be appropriate for presentation to the vehicle operator given the characteristics of the operator's IVIS and the present conditions and state of the vehicle.

### BRIEF DESCRIPTION OF THE DRAWINGS

The following detailed description when taken in conjunction with the figures presented herein provide a complete disclosure of the invention.

FIG. 1 shows the high level organization of the system according to the invention.

FIG. 2 provides details of an enhanced electronic control module.

FIG. 3 provides details of the opportunity server of the invention of the related patent application.

FIG. 4 sets forth the logical process according to the invention of the related patent application for reference to the present invention.

FIG. 5 depicts the interactions and processes of the present invention in one exemplary embodiment.

FIG. 6 sets forth an embodiment of a logical process according to the present invention.

### SUMMARY OF THE INVENTION

The present invention “coalesces” multiple “opportunities” for presentation to a vehicle operator via an In-Vehicle Information System (“IVIS”) according to user preferences, IVIS characteristics and capabilities, and vehicle conditions and state. Opportunities may include offers and quotes for services or products which have been provided by one or more potential vendors in response to a request from the vehicle's on-board diagnostic systems or from a user-initiated query. Opportunities may also include advertisements provided by vendors.

Presentation of such opportunities may include text displays, color displays, graphic images, moving images (e.g. video clips), and/or audio. For example, graphically-rich and multimedia documents such as, but not limited to, HTML, wireless markup language (“WML”), extensible markup language (“XML”), and Adobe Portable Document Format (“PDF”) may be presented in total or part, including text, tables, lists, icons, colors, still images, animated graphics, video, and audio. Still images may include, but are not limited to, Graphic Interchange Format (“GIF”), bitmap images (e.g. “BMP”, TIF tagged image files), Windows Metafile (“WMF”), and Joint Photographic Experts Group (“JPEG”) objects. Animated graphics and video may include, but are not limited to, standard formats such as Graphic Interchange Format (“GIF”), Apple movies (MOV), Microsoft movies (AVI), and Motion Picture Experts Group (“MPEG”) objects.

Through the process of coalescing the opportunities prior to presentation to the vehicle operator, user preferences are applied such as filtering and sorting for preferred vendors, price and availability, and conditions of the vehicle are considered such as avoiding presenting distracting object types during high speed vehicle operation.

### DETAILED DESCRIPTION OF THE INVENTION

The present invention may be realized in conjunction with the anticipatory mobile system service brokering and resource planning invention disclosed in the related patent application, or alternatively, it may be realized in conjunction with other types of In-Vehicle Information System (“IVIS”) functions such as web browsing, on-line ordering, etc. The following disclosure sets forth the invention with respect to the embodiment in conjunction with the invention of the related patent application, and it will be recognized by those skilled in the art that the invention is useful and applicable to many other IVIS applications.

Therefore, we first present a review of the invention of the related patent application, which integrates the on-board diagnostics capabilities of mobile systems such as vehicles, location based services technologies, and networked supply chain management technologies to provide anticipatory arrangement of required services and maintenance actions. Based upon real-time fault condition detection in a mobile system and upon the system's location and direction of travel, one or more potential geographic points of service, preferably within the scheduled itinerary of travel, is determined. The fault or trouble indicators are then analyzed to determine minimum service provider characteristics (e.g. hours of operation, staff qualifications, equipment and parts on-hand, etc.), and quotes or estimates for expected service actions are solicited and collected from partner provider systems.

These quotes are analyzed and presented to the mobile system operator for selection, either manually or automatically, based upon user preferences. If a service provider is selected, the service is scheduled according to an estimated time of arrival of the mobile system, including arranging for parts to be procured in advance such that there is minimal delay to the travel itinerary for the completion of the service.

If no service provider is found or selected, a second wider search for potential providers may be made to minimize deviation from the itinerary, including solicitation of quotes and estimates, selection and scheduling of the service actions.

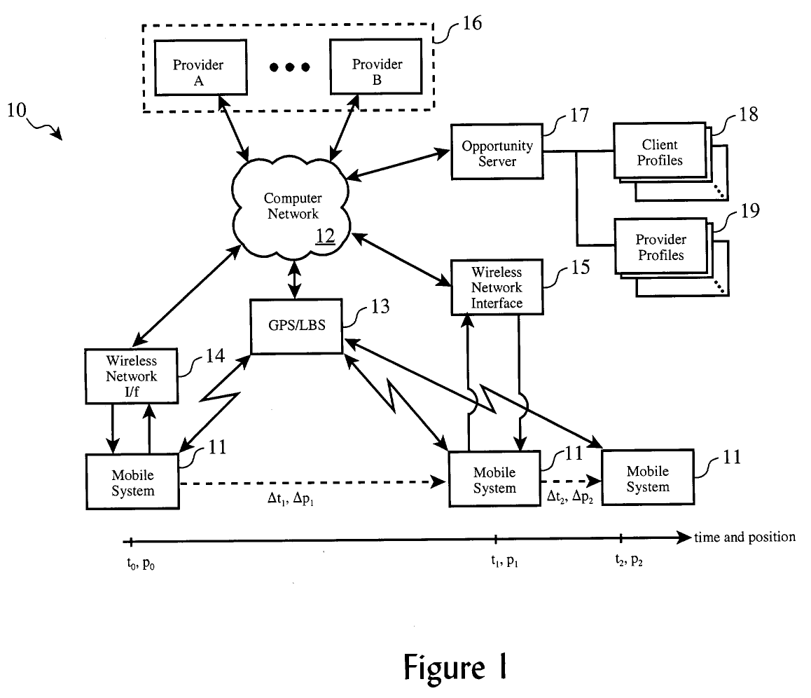

The system and method integrate several well-known technologies via an application server and one or more computer networks, as shown in FIG. 1. The following technologies and terminologies are used within this disclosure.

Location Based Services (“LBS”)—a set of services which are associated with and driven by the location of a device such as a wireless telephone, personal digital assistant, or other computer. LBS may use one of several available technologies to determine the geographic location of a device, including but not limited to GPS, the Federal Communication Commission's Enhanced 911 (“E911”) or micro-networks such as open-standard BlueTooth.

Global Positioning System (“GPS”)—any one of several available technologies for determining geographic position electronically, including most prevalently use of a network of satellites in geosynchronous orbit and a receiver to pinpoint the receiver's location. Older systems, such as LORAN and TRANSIT, may be used, as well. Regional positioning may be determined using signal triangulation or other methods commonly employed to determine in which cell in a cellular system a transceiver is located.

Computer network—most preferably the Internet, but also possibly local area networks (“LAN”), wireless area networks (“WAN”), private networks and intranets.

Wireless network—any suitable communications network for data transmission and reception including Personal Communications Systems (“PCS”), wireless LAN, light wave (e.g. infrared) networks, and radio-based data links, all of which may be of proprietary nature or may conform to one of many well-known wireless standards.

Mobile System—used generally to refer to any system which is able to diagnose its own faults and failures and which may be transported, and especially, but not limited to, the control and diagnostic computers for vehicles such as automotive Electronic Control Modules (“ECM”). A mobile system, however, does not have to be part of a vehicle, but may be vehicle-born, such as certain electronic systems carried in aircraft and ships which may need maintenance actions.

Enterprise Resource Planning (“ERP”)—broadly, a set of activities and technologies employed by businesses to effectively plan and use their resources, including materials ordering, order receipt and fulfillment, billing and accounts payable, personnel scheduling and the like.

Supply Chain Management (“SCM”)—a group of technologies and methods for coordinating the activities of multiple suppliers to achieve a goal such as delivering a service with certain materials. SCM includes the computer systems used to receive orders and requests for quotes, systems for determining current and future inventories, methods for calculating labor times and values, automated quote generation systems, and systems for executing orders and deliveries of materials.

Mobile System Diagnostic System—any system used to diagnose a mobile system such as a vehicle or other system which can be transported. We will use terms conventional to the automotive industry for this disclosure to broadly encompass similar terms from other mobile systems industries such as aviation, rail and maritime shipping. For example, we will refer to records regarding detected failures and potentially diagnosed root causes as Diagnostic Trouble Codes (“DTC”), and the computer which performs the monitoring of sensors, recording of failures and conditions, and transmission of DTC records as an electronic control module (“ECM”). It will be evident to those skilled in the art that the invention is not related to an automotive implementation, and that the use of these terms from automotive parlance is for understandability and presentation of a preferred embodiment only.

Opportunity, Offering, Bid—any data item which represents an offer for a service or product from a supplier, merchant or vendor to a consumer, user, or vehicle operator.

Coalesce—a process of forming together a data item presentation from a plurality of data items for a common purpose or disposition.

In-Vehicle Information System—a system for rendering and presenting information to a vehicle operator including, but not limited to, text displays, indicators, graphic screens, video monitors, and audio systems.

Turning now to FIG. 1, the general system organization (10) of the invention according to the related patent application is shown. A mobile system, such as a car ECM, initially is a location or position p₀ at an initial time to when a fault, failure or out-of-range condition is detected within a monitored system. Using a GPS or LBS subsystem such as a GPS receiver, the initial position p₀ is recorded with the DTC regarding the detected conditions, as well as with any DTC's which are the result of diagnostic analysis to determine the root cause of the detected condition.

For example, if a low fuel pressure level is detected, the ECM may record the position of the vehicle at the time the condition is detected in a first DTC, and may check other sensors for indications to assist in diagnosing the root cause of the failure. It may be diagnosed that the fuel filler cap may need to be checked or replaced. This diagnosis may be recorded in a second DTC, in typical ECM systems. According to the preferred embodiment, DTC's are recorded in a format commonly understood by automotive diagnostic computers, such as the International Standards Organization's Controller-Area Network (“CAN”) or Society of Automotive Engineers' J1850 format. Any format which records this information, however, may be equally well employed to realize the invention, especially for non-automotive applications as previously discussed.

These DTC's are then transmitted to an opportunity server (17), via a first wireless network, and secondly by a computer network (12). According to the preferred embodiment, the wireless network interface is an IBM eNetworks Wireless Switch coupled with convention wireless data communications facilities such as a Personal Communications System (“PCS”) transceiver. Other wireless network solutions, such as Motorola's Ricochet network, may be employed as well. The computer network is preferrably the well-known Internet, but may be a proprietary or private network (e.g. LAN, WAN, etc.).

The opportunity server receives the DTC's, consults a set of user profiles to determine any user preferences (19) known for the driver (e.g. preference to take his or her car to dealers only), and then determines if there are any potential providers in the future vicinity of the mobile system (e.g. next or previous town on the travel route). Those potential providers (16) are then issued a bid request using ERP and/or electronic data interchange (“EDI”) types of communications. To respond to the request for bid, each provider preferably certifies that they have (or will have) stock of necessary components, qualified staff on hand, and the necessary equipment to complete the maintenance action at the time of estimated arrival of the mobile system. Providers may be eliminated or sorted according to the user preferences, such as manufacturer dealers, automobile association ratings, etc.

One or more providers (16), then, may respond with quotes and estimates, which are then coalesced by the opportunity server (15) for downloading and presenting to the mobile system operator (e.g. car driver) via the computer network (12) and wireless interface (14). Presentation of the operator's options may be made graphically using a display on the vehicle's control panel (e.g. a TFT or LCD display on a car dashboard, computer display on a ship's helm, etc.), or audibly via a speakerphone or stereo system. The vehicle operator may then select a provider, which causes the opportunity server to confirm the bid and appointment to the winning provider.

When the mobile system arrives at the anticipated location p₁ on or about the anticipated time of arrival t₁, the service action may be made without unnecessary delays waiting for parts, personnel, or shopping for an acceptable cost or price.

If no provider is selected or no acceptable bid is made in the first search, the opportunity server (17) may repeat the search and offer process for a subsequent location p₂ and expected time of arrival t₂ which is either part of the operator's desired itinerary or within an acceptable deviation from the desired itinerary.

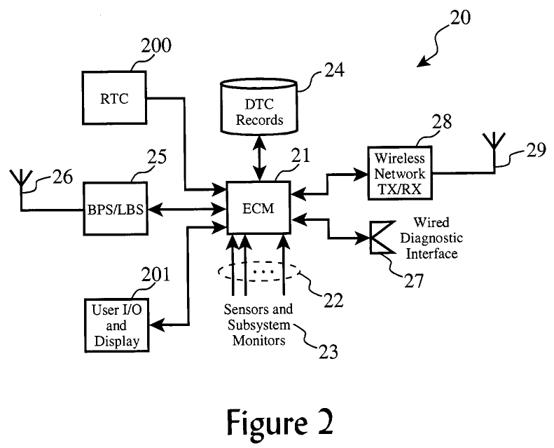

Turning to FIG. 2, details of the enhanced ECM (20) of the mobile system according to the disclosure of the related patent application are shown. The ECM (21), which includes a microprocessor or microcontroller, is interfaced (22) to a plurality of sensors and other subsystem monitors (e.g. controllers in a transmission, fuel injectors, etc.) via a bus such as the aforementioned J1850 or CAN bus, or appropriate proprietary or standard bus according to an alternate embodiment and vehicle application. Through this interface (22), the ECM receives information regarding detected failures, faults and out-of-range conditions, which are recorded in DTCs in the ECM memory (24).

The enhanced ECM (20) is also provided with location means, such as a GPS receiver or LBS-enabled wireless interface (25, 26), as well as a real-time clock (200). The location of the vehicle at the time of the detected event is recorded either with each DTC or in a separate DTC associated with the first DTC. Contact is then initiated through a wireless network interface (28, 29), such as a PCS interface, to the remote opportunity server, and the DTC's are transmitted or uploaded to the server.

Using the wireless network interface (28, 29), the enhanced ECM (20) may receive the coalesced opportunities (e.g. collected and qualified bids or offers from the providers) from the opportunity server, display or present them through the user interface (201), and receive a user selection. Presentation may be through a visual display, such as using an LCD or TFT display, or audibly using text-to-speech or telephone audio channels. The user's selection, such as a speech-recognized “yes” or “no” or input from a touch screen, may be transmitted back to the opportunity server via the wireless interface.

Some of these functions may be provided in combination with each other. For example, GPS operates on transmission of time-based signals from satellites to the GPS receivers, and as such, a GPS receiver includes a real-time clock. Also, a PCS phone which is LBS-enabled can also be employed as the wireless network interface.

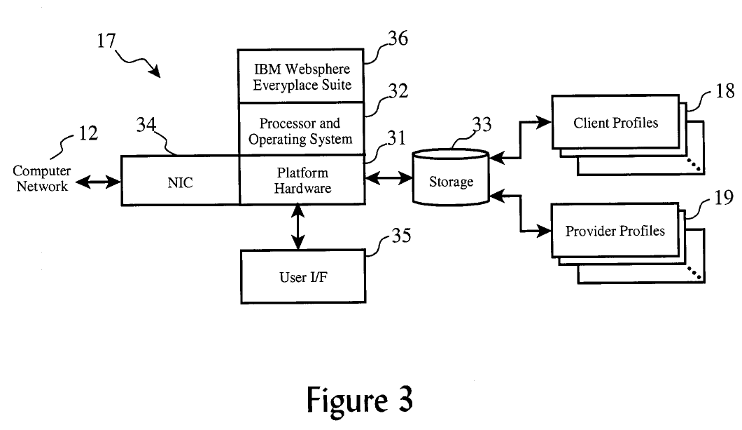

FIG. 3 provides more details of the opportunity server (17), which includes a common web server computing hardware platform (31) and operating system (32). The computing platform is preferrably an IBM eServer such as the IBM i-Series, or any other suitable computer platform such as an IBM-compatible personal computer, Sun Microsystem's server, or other capable computer. The hardware platform is also preferrably equipped with a network interface (“NIC”) (34) for communication with the computer network (12) such as the Internet. The NIC (34) may be as simple as a modem, or as sophisticated as a high bandwidth digital subscriber loop (“DSL) or T-1 interface (or better). The hardware platform is also preferrably provided with a set of user interface devices (35) such as a display, keyboard and mouse, for administration and configuration activities.

The operating system is preferrably IBM's AIX operating system, which is well adapted to web server applications, but may also be any other suitable operating system including but not limited to IBM's OS/2, Sun Microsystem's Solaris, Unix, Linux, or Microsoft's Windows. The opportunity server is also preferrably provided with one or more persistent storage devices (33) such as a disk array.

To realize the invention of the related patent application in the opportunity server, a web server suite, preferrably IBM's WebSphere Everyplace Suite, is provided with a number of application programs or scripts to implement the logical processes of the invention, as described in the preceding paragraphs and in more detail in the following paragraphs. The WebSphere product is well known in the industry, and methods and tools for implementing custom logical processes for networked business solutions are commonplace as the WebSphere product is widely in use by businesses, financial institutions, and government agencies around the world. Other suitable a capable software programs and/or suites may be utilized in place of the WebSphere product without departing from the spirit and scope of the present invention.

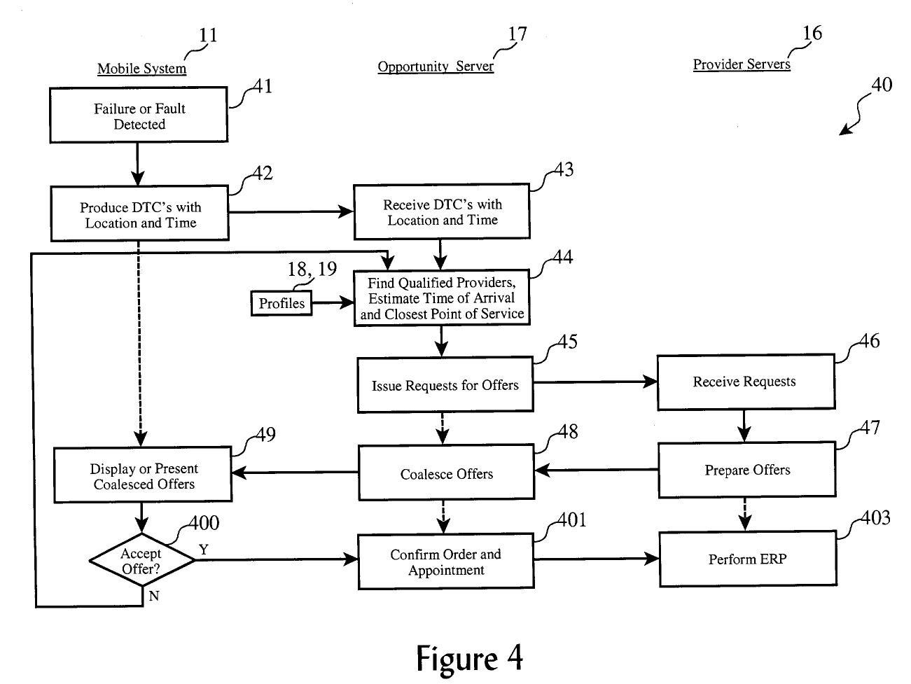

The logical processes are preferrably implemented in part in the mobile system's enhanced ECM (e.g. firmware or software), in part in the customizable logical processes (e.g. Java, scripts, etc.) on the opportunity server, and in part by the provider's servers. These logical processes are shown in FIG. 4 with their cooperative interactions.

When the enhanced ECM detects a fault condition, failure, or out-of-range measurement (41) on the mobile system, it produces (42) one or more DTCs, and transmits those with the mobile system's time and location to the opportunity server, preferrably via a wireless network.

The opportunity server then receives (43) the DTC's, and proceeds to check the user's profile and the provider profiles (18, 19) which are in the area of the next expected point of service (e.g. next or closest town, port, airport, etc.). Then, the DTC's are processed (45) to create requests for bids for the needed service repair, and are transmitted via the computer network to one or more provider servers.

Each provider servers receive (46) the requests, prepares (47) one or more offers if the provider is able to perform the maintenance service, and transmits these back to the opportunity server.

The opportunity server “coalesces” (e.g. modifies and combines) these offers by first screening them to meet the user's preferences, followed by organizing them into a format which is easily and uniformly presented to the mobile system operator. This may include performing text-to-speech conversion to allow for audible presentation via a telephone channel, adjusting and filtering graphics for presentation on a dashboard display which has limited capabilities, and minimizing text for quicker reading.

The coalesced offers are then transmitted preferably on the wireless network to the enhanced ECM, where they are presented to the mobile system operator (49) through display, audio, or both. The user can then accept an offer (400), such as by making a verbal election or touching an icon on a touchscreen, which results in the selection being transmitted to the opportunity server, which in turn performs a confirmation transaction (400) with the winning provider server. The selected provider server then performs enterprise resource planning functions (403) to order and deliver replacement parts to the point of service, schedule appropriately skilled personnel to be on call at the expected time of arrival, and to reserve an appointment for service.

If the mobile system operator declines all offers (402), then the opportunity server may widen the “bid pool” to include service providers which are located at a subsequent point of service (e.g. two towns away, two ports away, etc.), and/or which do not completely meet the user's preferences. For example, if the user prefers to have his car repaired at dealer-owned shops but no dealers are found, the bid pool is widened to include any qualified shops for the user's make of car.

To annotate FIG. 4 by way of example, suppose a car modified according to the present invention in route from Dallas to Austin, Tex., undergoes a failure in the fuel system. The ECM detects that fuel pressure is abnormally low, but that sensors on the fuel injectors indicate acceptable fuel flow. This causes a first DTC to be created for a low fuel pressure, and a second DTC to be created for a potential root cause of a loose or damaged fuel filler cap (42). Additionally, the location of the vehicle is determined using GPS, and a third time-location DTC is created.

When the opportunity server receives (43) these 3 DTC records, it immediately consults the user's profile and finds that he prefers to have his car repaired by the dealers associated with the manufacturer of his vehicle. So, using the location information, a database of providers is searched looking for dealers in the next town where the vehicle will be arriving, perhaps Waco, Tex., and towns which the vehicle has recently passed, perhaps Temple, Tex. This determination of points of service within the vehicle's vicinity can be made several ways. In its simplest form, the user may input the towns on the ECM's user interface, which can be included in the third DTC. Alternately, two successive GPS measurements can be made, which can be used to calculate vehicle direction and velocity, which can also be included in the DTC and used by the opportunity in conjunction with a digital map to determine upcoming towns on the vehicle's path. An estimated time of arrival can also be either calculated using this information, or provided directly by the vehicle operator.

Once a set of qualified providers has been determined, requests for bids can be transmitted to the provider's servers online, through means such as EDI, email, fax, etc. The providers' servers receive the requests, and in this example, determine if they can have parts (e.g. a fuel cap for the user's make and model of car) and skilled staff on hand at the estimated time of arrival of the vehicle. An offer can be generated, if desired, and transmitted back to the opportunity server, again using e-mail, EDI, fax, etc.

The opportunity server collects all of the returned offers, formats and filters (e.g. “coalesces”) them for presentation to the user, and sends them to the vehicle using the wireless network. In our example, let's assume that the quote price from two dealers is too high for the driver to accept, so he rejects (102) all of the offers, which allows the opportunity server to search for dealers in the next farther towns, perhaps Austin, Tex., and Grand Prairie, Tex., as well as for non-dealer service shops in Waco capable of performing the repairs. Requests for bids are produced and transmitted (45), and offers from 2 dealers in Austin and a Pep Boys store in Waco are received, coalesced (48), and presented (49) to the driver.

The driver then may select a lower priced dealer offer in Austin, if available, or a closer offer from Pep Boys if it is less expensive, which then results in the scheduling (403) of the service at the selected provider's facilities.

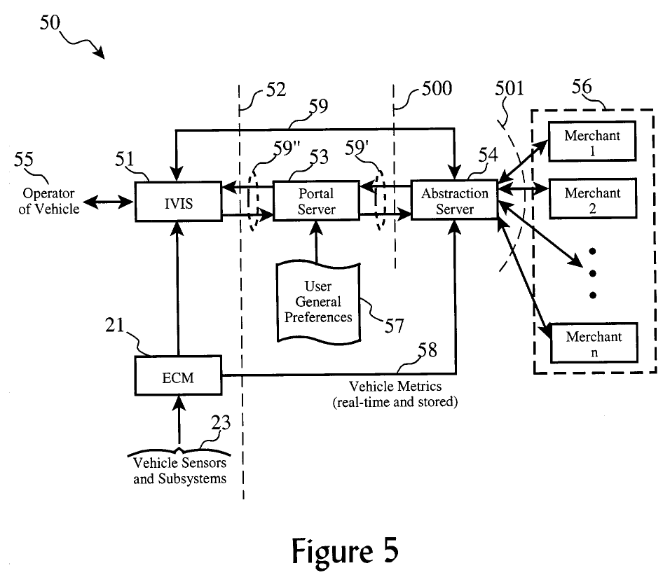

Turning now to FIG. 5, more details of the present invention of coalescing multiple opportunities for presentation to a user are given. In this figure, the opportunity server is represented in part or total by an abstraction server (54) potentially operating in coordination with a portal server (53). Additionally, the In-Vehicle Information System (51) represents display, audio and presentation capabilities of the vehicle such as a touch screen display, text display, audio system, etc., operating in coordination with (or as part of) the vehicle ECM (21), as previously discussed.

This arrangement (50) of systems allows the ECM (21) to provide to the abstraction server (54) vehicle metrics (58), such as real-time information (e.g. vehicle speed, direction, air bag status, operational status, etc.), as well as stored conditions (e.g. DTC's, history logs, etc.) The vehicle metrics (58) may be transmitted by an enhanced ECM (21) using any of the previously disclosed communications technologies (52) the vehicle to computer network or server, such as wireless data modems, cellular modems, etc.

The abstraction server (54) posts to one or more backend services from merchant servers (56) a request for offer, bid or opportunity, including any required format characteristics for the reply such as HTML, XML, PDF, electronic data interchange (“EDI”), etc. The merchant servers (56) may then reply with electronic documents or data items conforming to the general requirements issued by the abstraction server (54), including optional content within those bounds such as text, color, images, video, audio, etc. These replies represent one or more opportunities for the operator of the vehicle (55) for a needed service or product, as previously described.

The abstraction server (54) may coalesce the opportunities into a single presentation for the vehicle operator (55), making the presentation directly (59) to the operator through the IVIS, or indirectly via (59′, 59″) a portal server (53). The process actions described in the following paragraphs may be performed solely by the abstraction server (54), or may be performed in concert by the portal server (53) working with the abstraction server (54) in alternate embodiments.

Upon receipt (51) of one or more opportunities from the merchant server (56) backend processes, the abstraction server (54) filters the content of each opportunity for optimized presentation and rendering on the targeted IVIS. The filtering is performed at several levels, including mode and bandwidth characteristics of the vehicle and IVIS.

The mode of the IVIS indicates its ability to present or render certain types of media, such as audio, color, video, etc. Some IVIS systems may only be capable of displaying short text strings, such as a Liquid Crystal Display (“LCD”) on a dashboard gauge cluster. Other IVIS systems may be capable of color, graphic display via a Thin Flexible Transistor (“TFT”) display, and others may be able to play audio through a speaker or the vehicle's entertainment system. So, in one level of filtering, the abstraction server removes any media objects from the opportunities which can not be rendered on the targeted IVIS. Additionally, media objects which are not preferred (57) by the user may be filtered out or converted to a preferred media type. For an IVIS which only has audio capabilities, this level of filtering includes rendering operations such as performing text-to-speech conversion such that text in the opportunities is converted to grammars or playable audio data (e.g. WAV, MP3, etc.) which can be delivered to the IVIS for presentation. For an IVIS which has monochromatic display capabilities (e.g. non-color display), this level of filtering includes rendering monochrome or gray scale images from color images contained in the opportunities.

In the second level of filtering, the abstraction server (54) performs content adjustment based upon vehicle metrics which include the communications bandwidth available to the vehicle as well as other vehicle conditions indicated by the vehicle sensors (23) and stored conditions. This level of filtering includes compressing data to accommodate lower baud rates of communication, converting text to speech data at higher data rates (e.g. greater fidelity) or lower data rates (e.g. compressed), enabling or blocking streaming video depending on the ability of the communications link to support this media type, etc. If several communications mediums are used in series or tandem to communicate from said servers to the IVIS (e.g. a wireless link, an Internet TCP/IP port, a LAN port, etc.), the bandwidth of the medium having the lowest bandwidth capability can be selected for this filtering stage.

Additionally, certain types of media objects may be blocked from presentation or converted in this level of filtering based upon vehicle conditions such as the vehicle's speed. For example, if the vehicle is moving at a high speed (e.g. a car on a highway) in a known congested area (e.g. GPS indicates city travel during rush hour), the abstraction server can block presentation of full motion video media objects to avoid distracting the vehicle's operator during presentation. In an even more conservative configuration, under such vehicle conditions, the abstraction server may block presentation of all viewable media objects (e.g. text, images, color, etc.), and perform text-to-speech on all text within the opportunities to render an audio-only presentation.

As an extension to or part of the opportunity server, the enhanced coalescing processes of the present invention may also sort or eliminate from presentation opportunities from vendors and merchants according to the user's general preferences (57), as previously discussed. For example, if seeking hotel accommodations, the user may generally prefer to stay a hotels owned and operated by Accor Corporation (e.g. Red Roof Inns, Hotel Ibis, Motel 6, Novotel, Sofitel, etc.), or hotels which give certain frequent flyer miles credit for stays (e.g. OneWorld credits usable on American Airlines, British Airways, Cathay Pacific, Qantas, Aer Lingus, etc.). Additionally, the user may prefer to stay within a quarter-mile of major highways and interstate freeways, on or below a second floor, and in nonsmoking rooms. Nonconforming opportunities would be eliminated from the coalesced presentation, or sorted to last (or bottom) of the presentation.

Communications (59′) of functions divided between the abstraction server (54) and portal server (53) may be in accordance with implementation methods, such as interprocess communications on the same server processor, or interprocess communications over a computer network for distributed processes. Likewise, communications (501) between the abstraction server (54) processes and the merchant server (56) backend processes may be within a single computing environment (e.g. running on the same server) or within a distributed, networked computing environment (e.g. over a LAN, WAN or Internet).

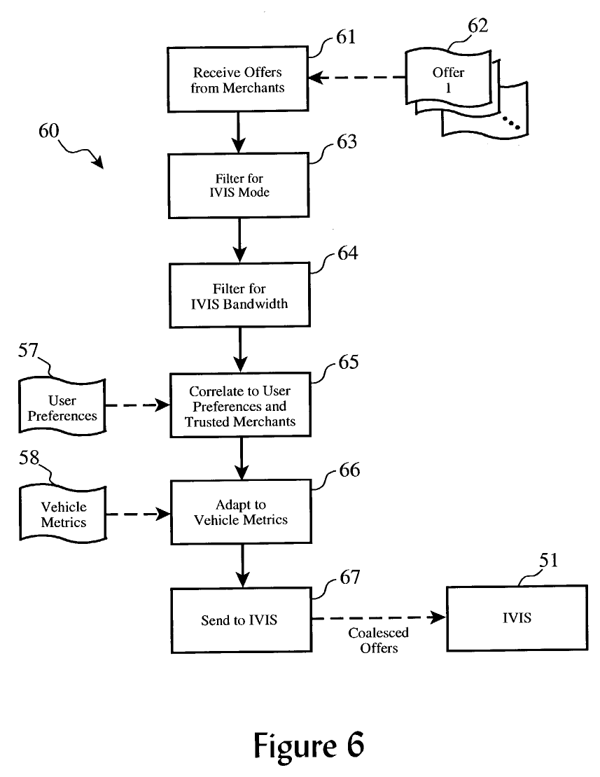

FIG. 6 sets forth a logical process (60) of an embodiment of the invention for coalescing a plurality of opportunities for presentation to a vehicle operator, as previously described. The abstraction server receives (61) one or more or more offers (62) or opportunities from one or more merchants, suppliers, service providers or vendors. The content of the offer(s) is filtered (63) based upon the mode of the IVIS, as well as being filtered (64) for bandwidth to the vehicle. The user's general preferences (57) are accommodated (65), and the presentation is adapted, filtered and adjusted (66) based upon vehicle metrics (58). This coalesced opportunities are then sent (67) to the to the UVIS (51) for presentation or rendering to the vehicle operator.

The invention presented herein meets the objectives and needs not presently met by systems and methods currently available. Certain details of embodiments have been provided for illustration, which do not indicate limits or restrictions to the use or realization possibilities of the present invention. It will be recognized by those skilled in the art that alternate embodiments including, but not limited to, application of the invention to other service and product procurement processes, use of alternate programming methodologies, computing environments and communication schemes are available within the scope of the invention.

What is claimed is:

1. A method comprising:
receiving one or more offers from a bidding server;
filtering said offers to accommodate a mode of an in-vehicle information system;
adjusting content of said filtered offers according to a communications bandwidth capacity to said in-vehicle information system; and
coalescing said adjusted and filtered offers into a presentation to a vehicle operator according to a set of general operator preferences, said coalesced presentation being rendered by said in-vehicle information system.

2. The method as set forth in claim 1 wherein said step of filtering offers to accommodate a mode of an in-vehicle information system comprises removing media objects from offers which the in-vehicle information system is incapable of rendering.

3. The method as set forth in claim 2 wherein said step of removing media objects comprises removing an object selected from the group of text, still images, color objects, animated images, audio, and video.

4. The method as set forth in claim 1 wherein said step of adjusting content according to communications bandwidth comprises selecting a lowest bandwidth available in a series of communications mediums between a server and a vehicle.

5. The method as set forth in claim 1 further comprising removing content from said offers according to vehicle metrics and content restriction rules conditional to said vehicle metrics.

6. The method as set forth in claim 5 wherein said step of removing content according to vehicle metrics comprises consideration of a vehicle metric selected from the group of vehicle travel state, vehicle geographic location, time, and vehicle speed.

7. The method as set forth in claim 1 further comprising initially indicating to one or more merchant servers a set of general offer content requirements.

8. A computer readable medium encoded with software for performing the steps of:
receiving one or more offers from a bidding server;
filtering said offers to accommodate a mode of an in-vehicle information system;
adjusting content of said filtered offers according to a communications bandwidth capacity to said in-vehicle information system; and
coalescing said adjusted and filtered offers into a presentation to a vehicle operator according to a set of general operator preferences, said coalesced presentation being rendered by said in-vehicle information system.

9. The computer readable medium as set forth in claim 8 wherein said software for filtering offers to accommodate a mode of an in-vehicle information system comprises software for removing media objects from offers which the in-vehicle information system is incapable of rendering.

10. The computer readable medium as set forth in claim 9 wherein said software for removing media objects comprises software for removing an object selected from the group of text, still images, color objects, animated images, audio, and video.

11. The computer readable medium as set forth in claim 1 wherein said software for adjusting content according to communications bandwidth comprises software for selecting a lowest bandwidth available in a series of communications mediums between a server and a vehicle.

12. The computer readable medium as set forth in claim 1 further comprising software for removing content from said offers according to vehicle metrics and evaluating content restriction rules conditional to said vehicle metrics.

13. The computer readable medium as set forth in claim 12 wherein said software for removing content according to vehicle metrics comprises software for consideration of a vehicle metric selected from the group of vehicle travel state, vehicle geographic location, time, and vehicle speed.

14. The computer readable medium as set forth in claim 8 further comprising software for initially indicating to one or more merchant servers a set of general offer content requirements.

15. An offer coalescing system comprising:
an offer receiver for receiving one or more offers from one or more bidding servers;
an IVIS mode filter configured to filter said received offers to accommodate a modal restrictions of a targeted in-vehicle information system;
an offer content adjuster adapted to adjust content of said filtered received offers according to a communications bandwidth capacity to said targeted in-vehicle information system; and
an offer coalescer configured to further adjust, filter and combine content of said offers into a presentation to a vehicle operator according to a set of general vehicle operator preferences for rendering by said in-vehicle information system.

16. The offer coalescing system as set forth in claim 15 wherein said IVIS mode filter comprises a media object remover for removing media objects which the in-vehicle information system is incapable of rendering.

17. The offer coalescing system as set forth in claim 16 wherein said media object remover is configured to remove an object selected from the group of text, still images, color objects, animated images, audio, and video.

18. The offer coalescing system as set forth in claim 15 wherein said offer content adjuster is configured to select a lowest bandwidth available in a series of communications mediums between a server and a vehicle.

19. The offer coalescing system as set forth in claim 15 wherein said offer content adjuster is configured to removing media objects from said offers according to vehicle metrics and content restriction rules conditional to said vehicle metrics.

20. The offer coalescing system as set forth in claim 19 wherein said offer content adjuster is configured to evaluate content restriction rules according to at least one vehicle metric selected from the group of vehicle travel state, vehicle geographic location, time, and vehicle speed.

21. The offer coalescing system as set forth in claim 19 further comprising an offer requirement indicator for initially communicating to one or more merchant servers a set of general offer content requirements.

22. The offer coalescing system as set forth in claim 15 wherein said UVIS mode filter, offer content adjuster, coalescer are configured to process offers containing media objects compatible with a format selected from the group of hypertext markup language, extensible markup language, portable document format, and electronic data interchange.

23. The offer coalescing system as set forth in claim 15 wherein said UVIS mode filter is configured to convert text media objects to audio media objects for rendering by IVIS incapable of visible display.

24. The offer coalescing system as set forth in claim 15 wherein said offer content adjuster is configured to perform compression of said offers according to available bandwidth to said IVIS.

25. The offer coalescing system as set forth in claim 15 wherein said coalescer is configured to convert text media objects to audio media objects when said vehicle metrics indicate a need to avoid visual distraction of a vehicle operator.
